(19) United States
(12) Patent Application Publication
(10) Pub. No.: US 2011/0141021 A1
(43) Pub. Date: Jun. 16, 2011

(54) HIGH PRECISION OPTICAL NAVIGATION DEVICE

(75) Inventor: Jeffrey M. RAYNOR, Edinburgh (GB)

(73) Assignee: STMicroelectronics (Research & Development) Limited, Marlow (GB)

(21) Appl. No.: 12/967,566

(22) Filed: Dec. 14, 2010

(30) Foreign Application Priority Data
Dec. 14, 2009 (GB) 0921798.5

(51) Int. Cl. G06F 3/033

(52) U.S. Cl. 345/166

(57) ABSTRACT

A handheld optical navigation device may include a first radiation source configured to produce a first beam of radiation onto a surface below the device, a first sensor configured to receive a first image based upon reflected radiation from the surface below the device, and to identify movement of the device based upon the first image for providing a first control action, and a second sensor configured to receive a second image based upon reflected radiation from an object different from the surface below the device, and to identify movement of the object based upon the second image for providing a second control action.

### FIELD OF THE INVENTION

This present disclosure relates to the field of handheld optical navigation devices, and in particular to those handheld optical devices used for computer navigation and control.

### BACKGROUND OF THE INVENTION

A computer mouse is a common user input device for a graphical environment. These devices may be handheld with the user moving the mouse with their hand, and more specifically, by twisting their wrist or moving their elbow. While this may produce large amounts of movement, the human body does not have very accurate control over the relevant muscles. Furthermore, the navigation/correlation technique used in the optical mouse may be inefficient at low speeds as there is little movement between successive images.

There have been a number of approaches to provide additional controls to the typical mouse. One such approach is the scroll wheel. The scroll wheel may provide extra control over the PC, but with usually a very coarse input, for example, to scroll a whole window. The movement, and hence control, is in one direction, usually the “Y” axis. One approach is a rotating wheel. There may be alternative input approaches, such as the Logitech (RTM) travel mice, which implement this using a capacitive touch pad.

The functionality of the scroll wheel may be improved, for example, by adding a “tilt” function to the scroll wheel. This has control in the orthogonal axis to the scroll, but by only a limited amount (−X, 0 or +X). As an alternative, another approach may replace the scroll wheel with a trackball on the top of the mouse. This is used to provide functionality similar to the tilt wheel, i.e. horizontal scrolling. Probably due to its small size, it may not be suitable as a main cursor control device. For some applications, for example, gaming, high speed may be desirable. For other applications, for example, Computer Aided Design (CAD), image drawing etc., very precise operation at low speed may be desirable.

### SUMMARY OF THE INVENTION

In a first aspect of the present disclosure, there is provided a handheld optical navigation device that may comprise a first radiation source capable of producing a beam of radiation onto a surface below the device, and a first sensor for receiving a first image based upon reflected radiation from the surface, and to identify movement of the device based upon the image to thereby enable a first control action to be carried out. The device may further comprise a second sensor for receiving a second image based upon reflected radiation from an object other than the surface and to identify movement of the object based upon the image to thereby enable a second control action to be carried out. The second sensor may provide at least one combined navigational output based upon the first and second control actions, i.e. the first and second control actions co-operate so as to provide for a single navigational output.

The device may comprise a second radiation source for producing a beam of radiation onto the object so as to obtain the second image. The device may comprise a mouse surface, the second sensor imaging movement of the object on the mouse surface. The device may be designed such that the mouse surface is easily manipulated by a finger or thumb.

The device may further comprise an optical element including at least one frustrated total internal reflection (F-TIR) surface capable of causing frustrated total internal reflection of the beam of radiation when the object contacts the mouse surface of the optical element, to thereby generate the second image. The optical element may comprise at least one further surface for directing radiation from the radiation source to at least one F-TIR surface. The optical element may comprise at least one additional surface for directing radiation from the F-TIR surface to the second sensor. The optical element may be formed from a single piece construction.

The first sensor and the second sensor may both share a single substrate. The device may comprise a controller for controlling the first and second sensors and the radiation source. The device may comprise separate control lines, motion lines and shutdown lines connecting the controller independently to each of the first and second sensor, the motion line for signaling if a sensor has detected movement and the shutdown line for enabling the controller to power down a sensor. Alternatively, the controller and the first and second sensors may be connected in series, such that the controller has direct control, i.e. motion and shutdown lines to only one of the sensors. In another embodiment, the device may comprise an additional control line such that the control pins of the first and second sensors are connected in parallel to a single controller pin.

The device may be operable such that for high speed operation, data from the first sensor is used, and for high precision operation, data from the second sensor is used. The device may be operable such that should a parameter related to the speed of movement of the device across the surface indicate a speed above a threshold, data from the first sensor is used for the control action and should the parameter related to the speed of movement of the device across the surface indicate a speed below the threshold data, data from the second sensor is used for the control action. The device may be operable such that the second sensor is deactivated when not being used for deriving the control action.

The device may be operable such that the second sensor is less sensitive to movement than the first sensor. The output resolution of the first sensor may be larger than the output resolution of the second sensor.

### BRIEF DESCRIPTION OF THE DRAWINGS

Embodiments of the present invention may now be described, by way of example only, by reference to the accompanying drawings, in which:

FIG. 1 shows a prior art mouse device;

FIG. 2 shows a mouse device according to an embodiment of the present invention;

FIG. 3 shows a mouse device according to a further embodiment of the present invention;

FIG. 4 shows a first system architecture for a mouse device according to an embodiment of the present invention;

FIG. 5 shows a second system architecture for a mouse device according to an embodiment of the present invention;

FIG. 6 shows a third system architecture for a mouse device according to an embodiment of the present invention;

FIG. 7 shows a plot of the speed of the mouse, according to the present invention, as detected by the down-facing sensor against its actual speed; and

FIG. 8 shows a plot of the speed of the mouse, according to the present invention, as detected by the up-facing sensor against its actual speed.

### DETAILED DESCRIPTION OF THE PREFERRED EMBODIMENTS

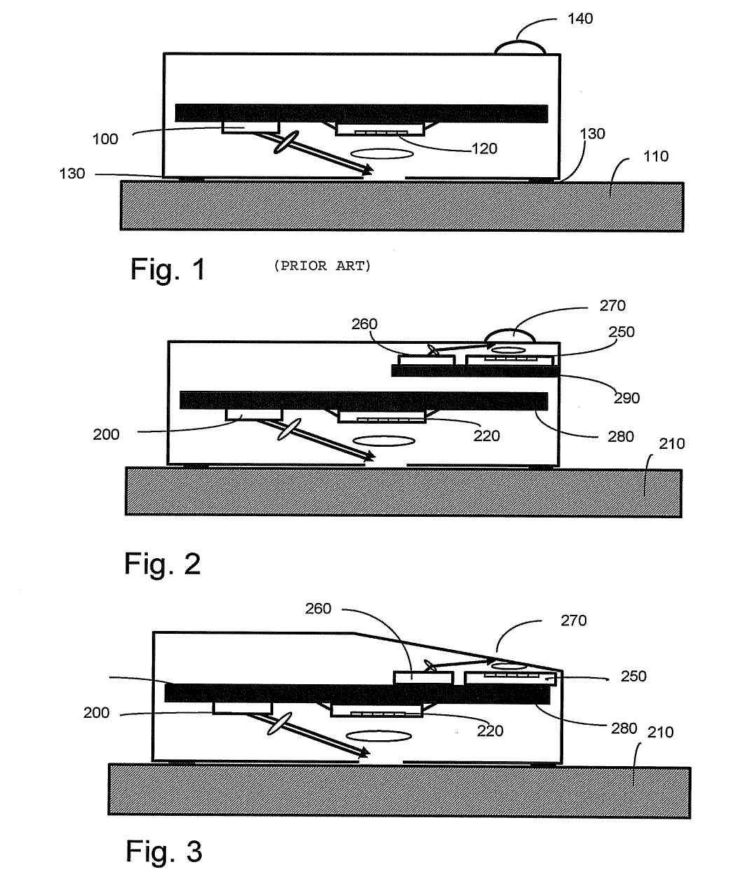

FIG. 1 shows the cross section of a typical optical mouse. Shown is a light source (LED or VCSEL) 100, from which light is directed/focused onto an object (table, desk, paper, mouse mat) 110, and the resulting image observed on an optical sensor 120 which tracks movement. Typically there are low-friction pads 130 mounted on the optical mouse to reduce friction and allow the mouse to move smoothly over the surface. Typically there are one or more buttons on the top of the mouse (not shown), and usually a scroll wheel or tilt wheel 140.

FIG. 2 shows a cross section of a mouse device according to one embodiment of the invention. This mouse includes a second optical sensor unit 250 and associated light source 260. Preferably the “Mouse surface” 270 provided by this second sensor arrangement 250, 260 is positioned directly underneath the position of the index finger when it is in a relaxed or comfortable state. Consequently the sensor unit 250 may receive an image based on light reflected off an object, such as a finger, on the mouse surface 270. The first optical sensor 220 and light source 200 are located on a first, main substrate (printed circuit board, PCB) 280. The second optical sensor (and associated light source) is mounted on a second substrate (PCB) 290. As an alternative to the arrangement depicted, the mouse surface could be on a side of the device (with a plane approximately perpendicular to that depicted) for manipulation by a thumb.

FIG. 3 shows an improved mouse from that of FIG. 2. By careful design of the mouse housing, the second optical sensor 250 and associated light source 260 has been mounted on the same substrate 280 as the first optical sensor 220. This reduced the thickness and provides greater comfort to the user and also decreases the manufacturing cost.

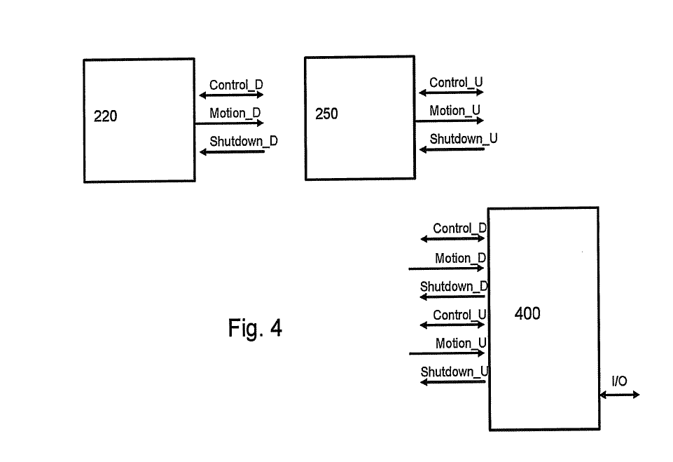

FIG. 4 illustrates one of a number of exemplary implementing architectures according to an embodiment of the invention. It shows the first motion sensor (looking down) 220, the second motion sensor (looking up) 250 and the controller 400, which may be an I2C or SPI or similar control interface. In particular, the connections of the “control,” “Motion,” (used to signal if the sensor has detected movement) and (optionally) “Shutdown,” (used by a host to power down a sensor to save energy) pins are shown for the sensors 220, 250 and controller 400. In this example “Motion” and “shutdown” are independently connected to the controller device 400. The output from the controller 400 is preferably a USB (universal serial bus) output or may even be a signal suitable for RF (radio frequency) modulation, in the case of a wireless mouse. The disadvantage of this system is the extra wires and input pins used add to the complexity and cost of the mouse.

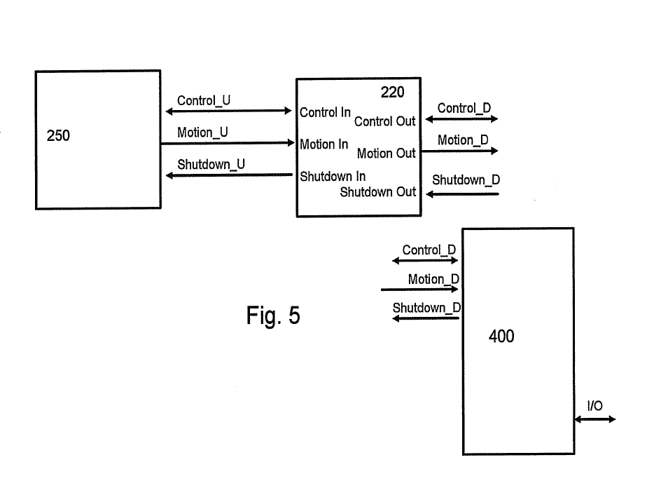

FIG. 5 shows an optimized system where the controller device 400 is connected to only one sensor 250. Due to size constraints, the down-facing sensor {desk} 250 has more space available than the up-facing {finger} sensor 220. Therefore, the down-facing sensor 250 would typically receive the inputs from the up-facing sensor 220 and modify/relay these to the controller 400. In the arrangement of FIG. 4, the decision to use either the down-facing sensor or up-facing sensor is made by the controller device 400. In the arrangements of FIGS. 5 & 6, the up facing sensor 220 would be programmed (typically via the control interface) with the speed threshold and the switching between the sensors being made by up facing sensor 220.

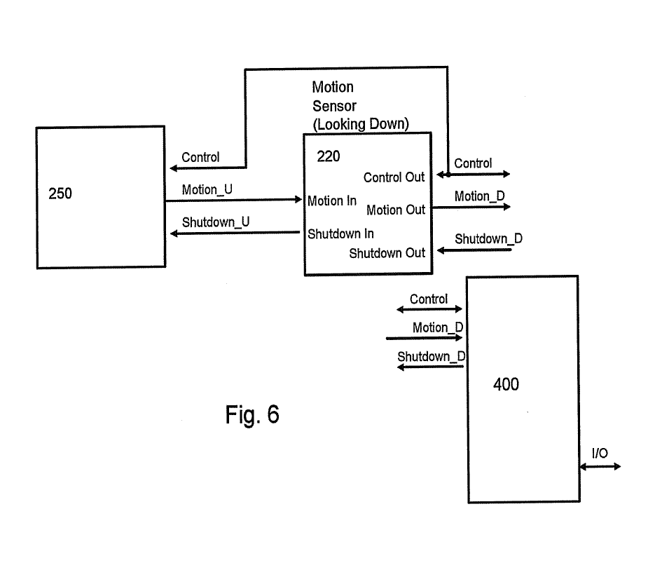

FIG. 6 shows a more efficient system architecture which may be possible, depending on the control bus uses. For example, if an I2C bus is used, there is no need to have a control input on the down-facing sensor 220, thus dispensing with the need of two extra pads/connections on the device. Furthermore, the I2C bus supports multiple (slave) devices, which means that the two sensors 220, 250 can be connected in parallel.

In a main embodiment, an aspect to the invention is the operation of the device, in that the device operates by using the two control signals from the two optical sensors in a co-operative manner so as to output a single navigation output. For large movements and high speed operation, the mouse itself is moved across the surface below it, and motion data from the down-facing sensor 220 is used. For high precision movements, the mouse is kept largely stationary and the finger (typically index) is moved over the mouse surface 270 of the device. As the human body possesses fine motor control on the fingers, this operation results in a device which provides increased accuracy control. In order to best achieve this operation, data from the down facing sensor 220 should be ignored for the purposes of control when the mouse is largely stationary, or its speed is below a threshold level.

As noted above, the output from the two sensors provides for a single navigational output. This is as opposed to an output that comprises two separate positional signals as is the case with a mouse and scroll wheel, where the mouse controls a cursor and the scroll wheel controls the scrolling in a window.

In the present embodiment, the two control signals would, for example, control the same cursor, providing a coarse control and fine control of the cursor. Clearly, control is not limited to that via a cursor, and the control method could be any other suitable method, including scroll, zoom etc.

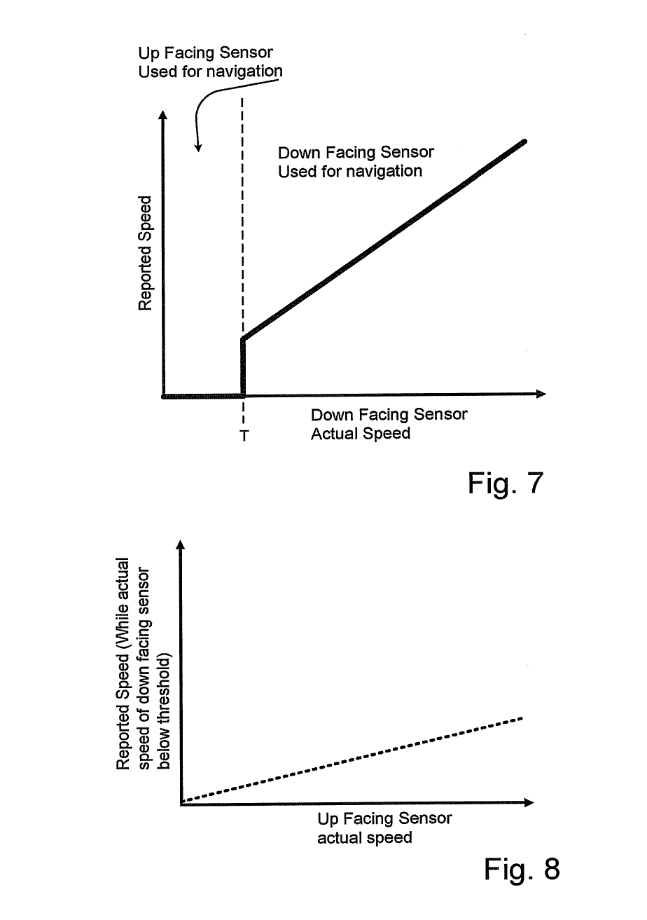

FIG. 7 shows a plot of the speed of the mouse as detected by the down-facing sensor 220 against its actual speed for a mouse configured in this way. When the detected speed of the mouse is above a certain threshold T, for example, 2-5 mm/sec, the navigation data from the down-facing sensor 220 is used, and the reported speed increases linearly with increase in actual speed (Of course, this relationship does not need to continue in a linear fashion but instead may “accelerate” as is known in the art). During this second period, data from the up facing sensor 250 is being ignored, and the sensor 250 and corresponding light source 260 may in fact be switched off.

When the speed drops below the threshold T, the data from the down-facing sensor 220 is disregarded and the reported speed drops to zero (first period on graph). During this period data from the up-facing sensor 250 is used instead. This technique avoids small nudges in the mouse when a user is sliding a finger on the top surface from being used as valid cursor movement data.

Optionally, the output resolution (counts per inch) from the two sensors can be made different, such that the down-facing sensor outputs 800 cpi, i.e. one inch of travel outputs 800 counts, while the up facing sensor outputs 200 cpi. Therefore, in the latter case, the finger has to move further to output the same number of counts. This decrease of sensitivity increases the positional accuracy of the system. The different output counts may be achieved either by changing the motion gain on the sensor or by varying the magnification in the optics (×0.5 Vs ×0.25) or by using sensors with different array sizes (20*20 pixels Vs 40*40 pixels).

FIG. 8 shows a graph similar (axes are scaled the same) to that of FIG. 7 for the up facing sensor 250 during the first period of graph 7. It can be seen that the reported speed increases linearly with actual speed of the finger on the sensor, but with a different slope than that of FIG. 7, representing the difference in output resolution. Of course, the reported speed on this graph drops to zero should the mouse speed recorded by the down facing sensor 220 pass the threshold value T.

It should be noted that the output from a mouse is rarely the actual “speed,” but is usually measured in counts. The speed is deduced by the controller, PC or mobile phone handset by monitoring the speed and time, i.e. speed =distance/time. Speed is used on FIGS. 7 and 8 as it clearly explains the operation of the device. The above embodiments are for illustration only and other embodiments and variations are possible and envisaged without departing from the spirit and scope of the invention.

1-17. (canceled)

18. A handheld optical navigation device comprising:
at least one radiation source configured to produce a first beam of radiation;
a first sensor configured to
receive a first image based upon reflected radiation from a surface, and
identify movement of the device based upon the first image for providing a first control action; and
a second sensor configured to
receive a second image based upon reflected radiation from an object different from the surface,
identify movement of the object based upon the second image for providing a second control action, and
provide at least one combined navigational output based upon the first and second control actions.

19. The handheld optical navigation device according to claim 18 wherein said at least one radiation source further comprises a first radiation source configured to provide the first beam of radiation and a second radiation source configured to produce a second beam of radiation onto the object for obtaining the second image.

20. The handheld optical navigation device according to claim 19 further comprising a housing carrying said first and second sensors and said first and second radiation sources, and having an upper surface thereon; and wherein said second sensor is configured to image movement of the object on the upper surface.

21. The handheld optical navigation device according to claim 20 wherein the upper surface is configured to be manipulated by a finger of a user.

22. The handheld optical navigation device according to claim 20 wherein the upper surface is configured to be manipulated by a thumb of a user.

23. The handheld optical navigation device according to claim 20 further comprising an optical element carried by said housing and providing the upper surface, said optical element including at least one frustrated total internal reflection (F-TIR) surface configured to cause frustrated total internal reflection of the second beam of radiation when the object contacts the upper surface of said optical element, thereby generating the second image.

24. The handheld optical navigation device according to claim 23 wherein said optical element comprises at least one other surface configured to direct radiation from said second radiation source to said at least one F-TIR surface and at least one additional surface for directing radiation from the F-TIR surface to said second sensor.

25. The handheld optical navigation device according to claim 18 further comprising a common substrate for said first sensor and said second sensor.

26. The handheld optical navigation device according to claim 18 further comprising a controller configured to control said first and second sensors and said at least one radiation source.

27. The handheld optical navigation device according to claim 26 further comprising:
control lines configured to connect said controller independently to each of said first and said second sensor;
motion lines configured to signal if a sensor has detected movement; and
shutdown lines configured to enable said controller to power down a sensor.

28. The handheld optical navigation device according to claim 26 wherein said controller and said first and second sensors are connected in series.

29. The handheld optical navigation device according to claim 28 further comprising an additional control line configured to connect control pins of said first and second sensors in parallel to a controller pin.

30. The handheld optical navigation device according to claim 18 wherein data from said first sensor is used for high speed operation; and wherein data from said second sensor is used for high precision operation.

31. The handheld optical navigation device according to claim 30 wherein when a parameter related to a speed of movement of the device across the surface indicates a speed above a threshold, data from said first sensor is used for the first control action; and wherein when the parameter related to the speed of movement of the device across the surface indicates speed below the threshold, data from said second sensor is used for the second control action.

32. The handheld optical navigation device according to claim 31 wherein said second sensor is configured to be deactivated when not being used for deriving the second control action.

33. The handheld optical navigation device according to claim 18 wherein said second sensor is less sensitive to movement than said first sensor.

34. The handheld optical navigation device according to claim 18 wherein an output resolution of said first sensor is larger than an output resolution of said second sensor.

35. A handheld optical navigation device comprising:
a first radiation source configured to produce a first beam of radiation;
a first sensor configured to
receive a first image based upon reflected radiation from a surface, and
identify movement of the device based upon the first image for providing a first control action;
a second sensor configured to
receive a second image based upon reflected radiation from an object different from the surface, and
identify movement of the object based upon the second image for providing a second control action;
a second radiation source configured to produce a second beam of radiation onto the object for obtaining the second image;
a common substrate for said first sensor and said second sensor; and
a controller configured to control said first and second sensors and said first and second radiation sources and provide at least one combined navigational output based upon the first and second control actions.

36. The handheld optical navigation device according to claim 35 further comprising a housing carrying said first and second sensors and said first and second radiation sources, and having an upper surface thereon; and wherein said second sensor is configured to image movement of the object on the upper surface.

37. The handheld optical navigation device according to claim 36 wherein the upper surface is manipulated by a finger of a user.

38. The handheld optical navigation device according to claim 36 wherein the upper surface is manipulated by a thumb of a user.

39. The handheld optical navigation device according to claim 36 further comprising an optical element carried by said housing and providing the upper surface, said optical element including at least one frustrated total internal reflection (F-TIR) surface configured to cause frustrated total internal reflection of the second beam of radiation when the object contacts the upper surface of said optical element, thereby generating the second image.

40. The handheld optical navigation device according to claim 39 wherein said optical element comprises at least one other surface configured to direct radiation from said second radiation source to said at least one F-TIR surface and at least one additional surface for directing radiation from the F-TIR surface to said second sensor.

41. A method of operating a handheld optical navigation device comprising:
using at least one radiation source to produce a first beam of radiation onto a surface;
using a first sensor to receive a first image based upon reflected radiation from the surface, and to identify movement of the device based upon the first image for providing a first control action;
using a second sensor to receive a second image based upon reflected radiation from an object different from the surface, and to identify movement of the object based upon the second image for providing a second control action; and
providing at least one combined navigational output based upon the first and second control actions.

42. The method according to claim 41 wherein the at least one radiation source further comprises a first radiation source providing the first beam of radiation and a second radiation source; and further comprising using the second radiation source to produce a second beam of radiation onto the object for obtaining the second image.

43. The method according to claim 42 further comprising using the second sensor to image movement of an object on an upper surface.

44. The method according to claim 43 wherein the upper surface is manipulated by a finger of a user.
